(19) United States
(12) Patent Application Publication
(10) Pub. No.: US 2007/0174205 A1
(43) Pub. Date: Jul. 26, 2007

(54) System, method and storage medium for license management

(76) Inventor: Kazuo Saito, Tokyo (JP)

Correspondence Address: GAUTHIER & CONNORS, LLP, 225 FRANKLIN STREET, SUITE 2300, BOSTON, MA, 02110, US

(21) Appl. No.: 11/512,285

(22) Filed: Aug. 29, 2006

(30) Foreign Application Priority Data
Jan. 24, 2006 (JP) 2006-15475

(51) Int. Cl. G06Q 99/00

(52) U.S. Cl. 705/59

(57) ABSTRACT

There is provided a license management system including an issuance system that issues a license for digital content which includes an instruction to change a usage condition for a related license if the related license which has the usage condition to be changed exists, and a user system that, if a license for a digital content includes an instruction to change a usage condition for a related license and the related license is stored within the user system when the use of the digital content is instructed, changes the usage condition for the related license in accordance with the instruction.

### BACKGROUND

1. Technical Field

The present invention relates to the management of digital licenses for the use of digital content.

2. Related Art

A control technology for checking the existence of a valid right when using digital content (documents, videos, audios, general software, such as programs) and permitting a user to use the digital content only if the user possesses a valid right is called Digital Rights Management (DRM) technology. Known specific examples of a DRM system are access-ticket systems and Microsoft's Windows Rights Management System (WRMS).

DRM technology can be generally divided into online and offline systems. The online system issues an online inquiry regarding rights of use to a server from a user terminal (such as PC). The offline system performs rights authentication in advance and issues a right to use the digital content, namely, a license to a user terminal, and when the digital content is to be used, permits use of the digital content by referencing licenses within the user terminal.

For example, if the offline type of DRM is applied to software download sales, a license is generated at the server when a payment process is successful during a purchase. Thereafter, the license is managed at the terminal used by the user and can be continuously used until the expiration date of the license or the usage count is reached (or in perpetuity if there is no limit).

In actuality, there may be a request for a buy-back, transfer, or migration (movement of a license to another terminal) of a license. To achieve a buy-back, transfer, or migration of a license, it is necessary to delete the license from the terminal or invalidate the license.

On the other hand, software sales can take the form of migration licenses and upgrade licenses. A migration license is a license that is sold at a price lower than normal assuming the possession of a license of a competing product from another company. An upgrade license is a license that is sold for an upgraded software version at a price lower than normal assuming the possession of an earlier software version.

In either of these cases, once the use of a newly acquired license begins, there is a request to terminate (or inhibit) the use of the software that was the target of the migration or upgrade.

To meet this request in the related art, a license purchase page is displayed, and when a license is purchased, a process is performed at the same time to invalidate the old license.

### SUMMARY

According to an aspect of the invention, there is provided a license management system including an issuance system that issues a license for digital content which includes an instruction to change a usage condition for a related license if the related license which has the usage condition to be changed exists, and a user system that, if a license for a digital content includes an instruction to change a usage condition for a related license and the related license is stored within the user system when the use of the digital content is instructed, changes the usage condition for the related license in accordance with the instruction.

### BRIEF DESCRIPTION OF THE DRAWINGS

Exemplary embodiments of the present invention will be described in detail based on the following figures, wherein:

FIG. 1 shows an overall system configuration and a flow of processing when the sale of an upgrade license is achieved in the system of the related art;

FIG. 2 shows an overall system configuration and a flow of processing when the sale of an upgrade license is achieved in the system of an embodiment;

FIG. 3 is a block diagram showing one example of a functional configuration of a contents provider server;

FIG. 4 is a flowchart showing one example of a procedure for the contents provider server;

FIG. 5 is a block diagram showing one example of a functional configuration of a client PC;

FIG. 6 is a flowchart showing an example of a flow of processing that is executed within the client PC;

FIG. 7 is a flowchart showing one example of a procedure for a first modified example of the contents provider server;

FIG. 8 is a block diagram showing one example of a functional configuration of a first modified example of the client PC;

FIG. 9 is a flowchart showing an example of a flow of processing that is executed within the first modified example of the client PC;

FIG. 10 is a flowchart showing one example of a procedure for a second modified example of the contents provider server;

FIG. 11 is a flowchart showing an example of a flow of processing that is executed within a second modified example of the client PC; and

FIG. 12 shows one example of a hardware configuration of a contents provider server or a client PC.

### DETAILED DESCRIPTION

Exemplary embodiments of the present invention will be described hereinafter with reference to the attached drawings. A system of the embodiment based on an access-ticket method DRM system will be described hereinafter. As anyone skilled in the art can appreciate, the embodiment is applicable to various DRM systems and not only to access-ticket systems. Furthermore, the configuration and operation of a system of the embodiment will be described hereinafter using an example when selling an upgrade license from a system that sells software content. However, this is only one embodiment. As anyone skilled in the art can appreciate, a system of the embodiment is applicable to various application systems for managing the usage rights of users with respect to digital content, such as permitting or inhibiting the access of each user to in-house documents.

Electronic data called an access ticket (simply “ticket” hereinafter) in the access-ticket system represents a license signifying a digital content usage right. The ticket includes identification information of the target digital content (or more specifically, a key ID to be described later) and information on the usage condition for the digital content (usage mode, such as viewable, editable or executable, or term of validity or expiration date, maximum usage count, billing rate, and so forth). It should be noted that a ticket and a license fundamentally signify the same concept (data).

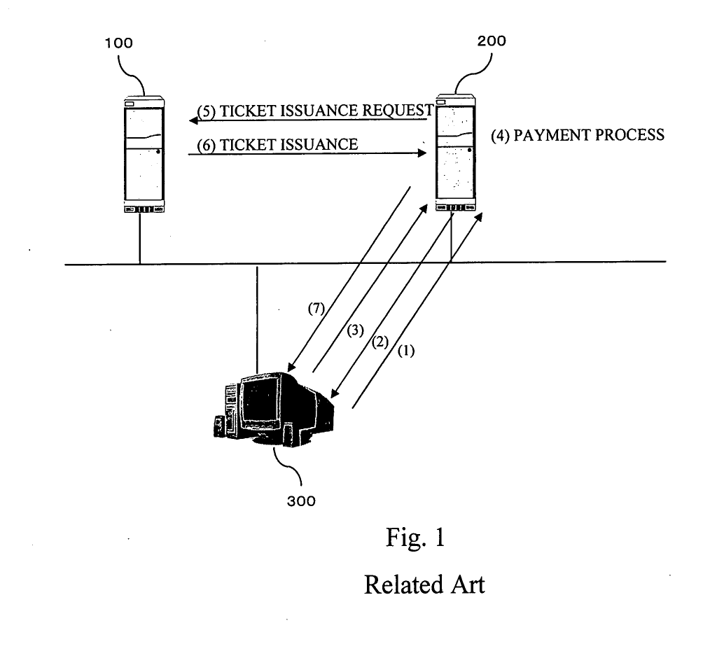

First, the overall system configuration and flow of processing are shown in FIG. 1 when implementing the sales of upgrade licenses in the system of the related art. This system is mainly formed from a ticket issuance server 100 for generating and issuing tickets, a contents provider server 200 for selling digital content, and a client PC (personal computer) 300 for use by a user to purchase digital content.

The contents provider server 200 is, for example, configured as a web server and stores encapsulated (protected by encryption) digital content (software).

Encapsulation of the digital content is performed in advance by using a dedicated encapsulation tool. Any of the various known encapsulation tools may be used. One example of an encapsulation process is given next for reference. The process:

(a) A public key for digital content encryption is first acquired from the ticket issuance server 100. An ID is assigned to the key so that the encapsulated digital content can be recognized from the key ID.
(b) The digital content for the encapsulation tool is next encrypted. The encryption process generates a digital content encryption key for encrypting the digital content, encrypts the entire digital content using the key, and further encrypts the digital content encryption key with the public key that was issued from the server. The encrypted contents key is combined with the entire encrypted digital content. Furthermore, a separate database (not shown) manages information showing the digital content and the key ID of the encryption key used to encapsulate the digital content. The database is located (for example, within the ticket issuance server 100 or on a network to which is connected the servers 100 and 200) where it is accessible from the ticket issuance server 100 or the contents provider server 200.

The user can access the contents provider server 200 from the client PC 300 and freely download the encapsulated digital content. However, since the encapsulated digital content is protected, such as via encryption, it is necessary for the user to purchase a ticket to use the digital content.

A specific example is given here where a license for software product A is being sold by the contents provider server 200. The newest version of software product A is 2.0 and an upgrade license is also available for upgrading from version 1.0 to version 2.0. Version 1.0 of the software has been encrypted with a key having key ID “1001” while version 2.0 of the software has been encrypted with a key having key ID “1002”.

The flow of processing in the system of the related art will be described with reference to FIG. 1 for a user who already has a license for version 1.0 and purchases a license for version 2.0. Numbers (1) to (7) shown hereinafter correspond to the numbers shown in FIG. 1.

(1) First, the user accesses the contents provider server 200 with a browser at the client PC 300 and sends a command indicating the upgrade license for the newest version (version 2.0) of software product A is to be purchased.

(2) The contents provider server 200 issues an inquiry to the client PC 300 and checks whether or not the user possesses a previous version (for example, version 1.0) of software product A. If the user is in possession of a previous version of software product A, a command is transmitted to the client PC 300 to invalidate the previous version. If the user is not in possession of a previous version, the server 200 notifies the client PC 300 of an error and the session for purchasing an upgrade license is terminated.

(3) The client PC 300 returns the processing result to the server. It is assumed here that a previous version exists in the client PC 300 and that the previous version is invalidated by a known invalidation process. The server 200, after receiving a notification that the invalidation was successful, performs downloading of the capsule of version 2.0 of software product A to the client PC 300.

(4) When the capsule is downloaded, the user performs a procedure to purchase a license for version 2.0. For example, the server 200 sends a payment web page to the client PC 300 and the user enters the necessary data, such as credit card number, into the page and returns the page to the server 200. The server 200 then performs payment (any payment mechanism may be used) for the purchase on the basis of the information that is sent from the user.

(5) After payment is complete, the contents provider server 200 issues a request to the ticket issuance server 100 for the issuance of a ticket for the client PC 300. At this time, a token ID for the client PC 300 is acquired and a ticket issuance is requested by specifying the token ID and the key ID (1002) of the capsule of version 2.0.

Here, a “token” refers to tamper-resistant hardware or software for managing unique key information assigned to every client PC for performing an authentication process. The client PC 300 is assumed to have been preinstalled with this token.

(6) The ticket issuance server 100 generates and returns a ticket for version 2.0 in accordance with the requested conditions.

(7) The contents provider server 200 receives the ticket from the ticket issuance server 100 and delivers the ticket to the client PC 300.

In the access-ticket system, the client PC 300 uses a combination of information included in the ticket and unique key information included in the token. Thus, when the digital content is to be used, the digital content encryption key corresponding to the encapsulated digital content is decrypted, the encapsulated digital content is decrypted using the decrypted digital content encryption key, and the user uses the digital content. It should be noted that the token ID and the unique key information for the client PC 300 are pre-registered in the ticket issuance server 100. The ticket issuance server 100 uses this information to issue an appropriate ticket that corresponds to the token of the client PC 300.

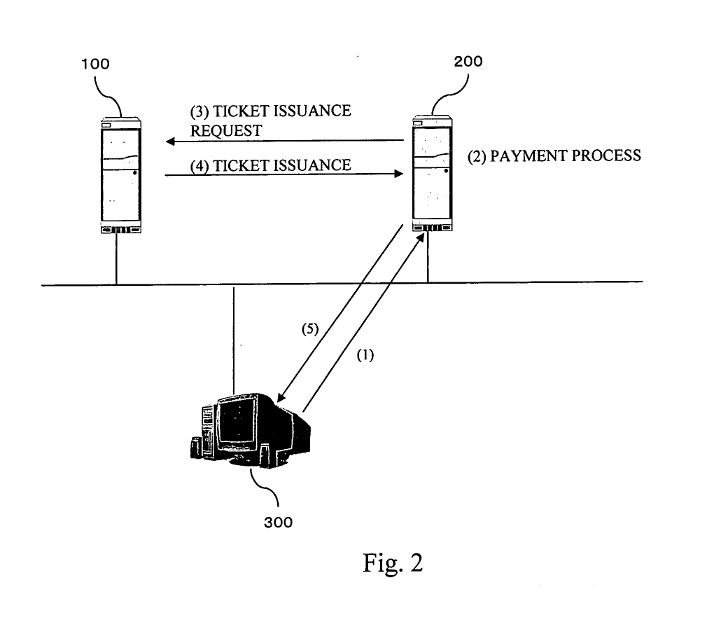

The flow of processing in the system of the related art was described hereinabove. Next, the flow of processing in the embodiment will be described with reference to FIG. 2.

(1) First, the user accesses the contents provider server 200 with a browser of the client PC 300 and sends a command indicating the upgrade license for the newest version (version 2.0) of software product A is to be purchased.

In the related art, the server 200 checks whether or not a previous version exists in the client PC 300. However, in this embodiment, this checking process is unnecessary.

The server 200 provides a capsule of version 2.0 of software product A to the client PC 300 regardless of whether or not a previous version exists.

(2) When the capsule is downloaded, the user performs a procedure to purchase a license for version 2.0 and the server 200 performs payment (any payment mechanism may be used) on the basis of information entered in the procedure by the user.

(3) After payment is complete, the contents provider server 200 issues a request to the ticket issuance server 100 for the issuance of a ticket for the client PC 300. At this time, the contents provider server 200 acquires the token ID of the client PC 300 and transmits the token ID and the key ID (1002) of the capsule of version 2.0 to the ticket issuance server 100. Furthermore, in this embodiment, the contents provider server 200 specifies usage conditions for the requested ticket to the ticket issuance server 100. The conditions are “a ticket of key ID (1001) of the capsule of version 1.0 exists” and “the ticket of key ID (1001) is invalidated when the ticket of key ID (1002) is used”.

(4) The ticket issuance server 100 generates an upgrade ticket for version 2.0 that includes information from the contents provider server 200 specifying the usage conditions and returns the upgrade ticket to the client PC 300.

(5) The contents provider server 200 receives the ticket from the ticket issuance server 100 and delivers the ticket to the client PC 300.

In the procedure above, the user acquires the upgrade ticket. When the use of version 2.0 of software product A is instructed by the user, the client PC 300 instructs that the capsule is to be used by using the upgrade ticket corresponding to version 2.0 for the token. The usage conditions are described in the ticket where the conditions are “a ticket of key ID (1001) of the capsule of version 1.0 exists” and “the ticket of key ID (1001) is invalidated when the ticket of key ID (1002) is used”. Therefore, the token is first checked to see whether or not the ticket of key ID (1001) exists within the token. If it does not exist, the use of the upgrade ticket (key ID 1002) is inhibited (namely, the key for decryption is not provided). Therefore, in this case, the user cannot use version 2.0 of software product A. On the other hand, if the ticket of key ID (1001) exists within the token, the token invalidates the ticket (key ID 1001) and then generates a decryption key for version 2.0 using the upgrade ticket (key ID 1002) so that the capsule of version 2.0 can be used.

In the system of the related art, when the upgrade ticket is provided to the client PC 300, the contents provider server 200 confirms whether or not a ticket of a previous version exists in the client PC 300. Compared to this, when an upgrade ticket is to be used in this embodiment, the token within the client PC 300 determines whether or not a previous version exists. If a previous version does not exist, the upgrade ticket cannot be used. Therefore, when providing an upgrade ticket in this embodiment, since it is not necessary for the server 200 to check whether or not a ticket for a previous version exists in the client PC 300, the load on the server 200 can be reduced.

Furthermore, in the system of the related art, the ticket for a previous version is invalidated when an upgrade ticket is provided so that the previous version becomes unusable and the newest version must be used. However, depending on the user, there are instances where only the purchase of an upgrade ticket is first performed and the previous version is used unless it becomes necessary to use the newest version. The system of this embodiment can handle this type of request. Namely, in this embodiment, until the use of the newest version of software product A is instructed, the ticket for the previous version is not invalidated so that the previous version can continue to be used. Once the use of the newest version is instructed, the token invalidates the ticket for the previous version in accordance with the usage conditions indicated on the upgrade ticket so as to prevent the ticket for the previous version and the ticket for the newest version from existing concurrently.

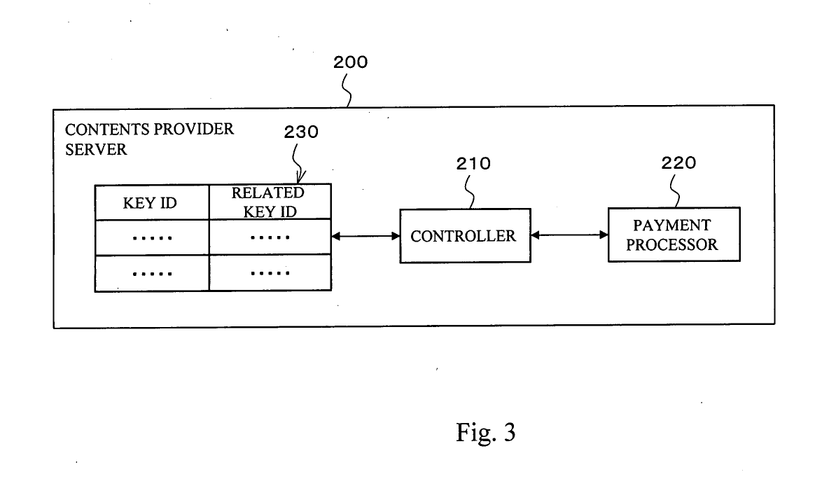

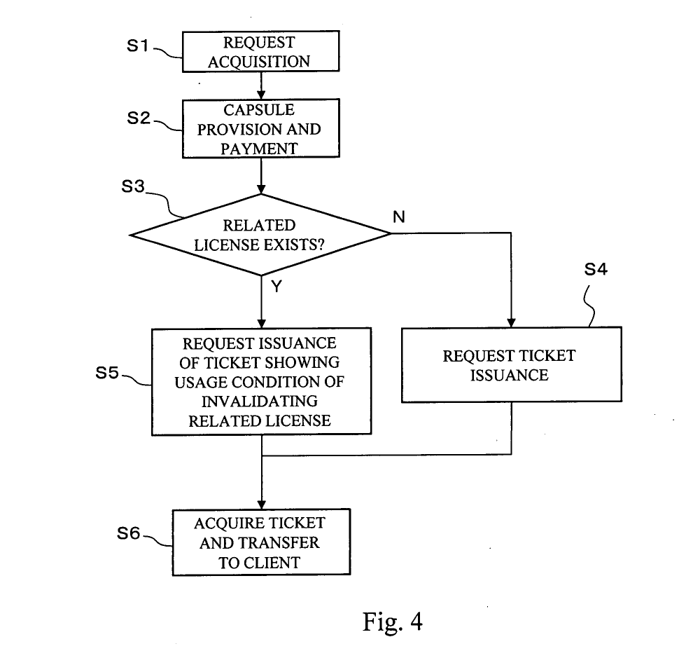

Details of the contents provider server 200 and the client PC 300 forming the system of the embodiment described above will be given hereinafter. First, one example of a configuration and procedure for the contents provider server 200 will be described with reference to FIG. 3 and FIG. 4.

As shown in FIG. 3, the contents provider server 200 includes a controller 210, a payment processor 220, and a license correlation information storage unit 230.

Among these components, the controller 210 performs overall control of services for the client PC 300. For example, in accordance with a request from the client PC 300, the controller 210 provides a web page for specifying the digital content to be downloaded and provides the digital content selected by the user from the web page. Furthermore, if payment is necessary to provide digital content, the controller 210 provides to the user a web page for entering the required payment information, passes the corresponding user-entered information to the payment processor 220 and performs payment. The payment processor 220 performs payment of the digital content purchase price using a known system.

Furthermore, the controller 210 executes a process necessary for providing to the user a ticket for the digital content. When processing the provision of the ticket, the controller 210 judges, by referencing the license correlation information storage unit 230, whether or not the user has a license relating to the license for the requested digital content. The related license is, in this case, a license that must be invalidated when the target license is used, and more specifically may be a license (ticket) for a previous version. The license correlation information storage unit 230 stores information including the license key ID (showing the digital content that is accessible from that license or ticket) and the related license key ID (related key ID) to be invalidated when the license is used. The license correlation information storage unit 230 may be registered with two or more related key IDs corresponding to the key ID of one license. The controller 210 checks whether or not a related key ID corresponding to the license key ID and to the user-requested digital content exists in the license correlation information storage unit 230. If one exists, the issuance of a ticket having the invalidation of the license (ticket) corresponding to the related key ID as a usage condition is requested from the ticket issuance server 100.

One example of the procedure for the contents provider server 200 is shown in FIG. 4. In this procedure, the server 200 first receives (S1) a digital content download request from the client PC 300 and then provides a capsule of the requested digital content to the client PC 300 as well as executes (S2) a payment process for the digital content price. If the payment process fails, the execution does not proceed and an error process is executed (not shown). If the payment process succeeds, the server 200 checks (S3) whether or not a license related to the license for using the digital content exists by referencing the license correlation information storage unit 230. If there is no related license, the server 200 sends the key ID corresponding to the digital content and the token ID of the client PC 300 to the ticket issuance server 100 and requests (S4) the issuance of a ticket for that digital content. In this request, a usage condition, such as the invalidation of a related license, is not specified so that the ticket issuance server 100 issues tickets in the same manner as in the related art.

When it has been judged that a related license exists in step S3, the server 200 specifies as usage conditions that “the token stores a ticket having key ID corresponding to the related license” and “when the ticket is used the ticket having key ID corresponding to the related license is invalidated” and issues a request (S5) to the ticket issuance server 100 for the issuance of a ticket corresponding to the relevant digital content. If there are multiple related licenses, the key IDs corresponding to the related licenses are listed for these usage conditions. The ticket issuance server 100 receiving this request issues a ticket that includes the usage conditions.

The ticket issued by the ticket issuance server 100 is received by the server 200 and transferred (S6) to the client PC 300.

The contents provider server 200 was described above. Next, the configuration and procedure for the client PC 300 will be described.

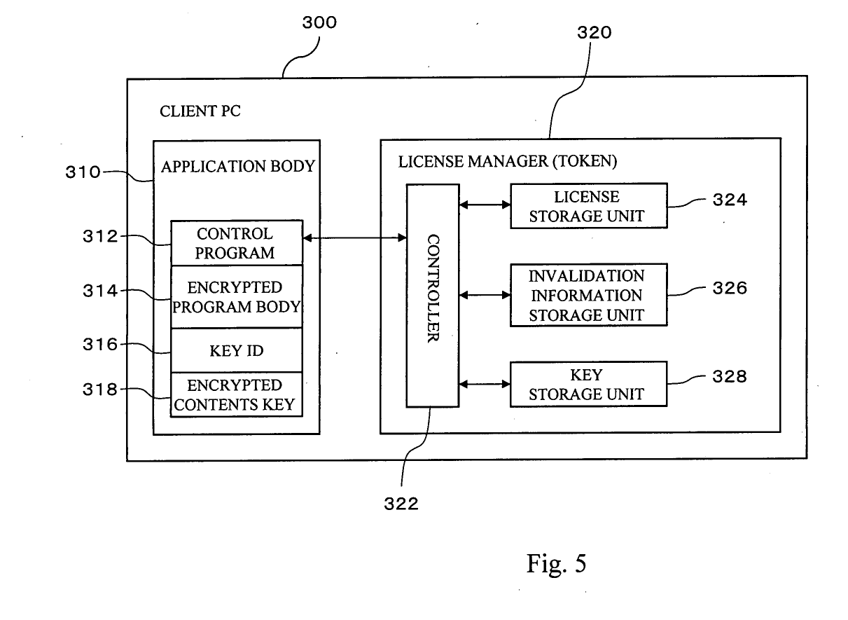

As shown in FIG. 5, the client PC 300 includes an application body 310 and a license manager 320 (token). The application body 310 is a capsule that was downloaded from the contents provider server 200 and includes a control program 312, an encrypted program body 314, a key ID 316, and an encrypted contents key 318. The control program 312 is executed when the application body 310 is started, and a process is executed to decrypt the encrypted program body 314. The encrypted program body 314 is the part that executes a process to provide the application body 310 to the user and is encrypted with the contents key. The encrypted contents key 318 is a contents key that has been encrypted for decrypting the encrypted program body 314. The key ID 316 is an ID that identifies the public key used to encrypt the contents key.

The license manager (token) 320 is a functional module for managing the tickets (licenses) for the respective capsules installed in the client PC 300. This module is installed as tamper-resistant software or hardware. The license manager 320 includes a controller 322, a license storage unit 324, an invalidation information storage unit 326, and a key storage unit 328. The license storage unit 324 stores ticket (license) data to use each capsule. Each ticket stored by the license storage unit 324 is searchable by key ID. Although FIG. 5 only shows one capsule (namely, application body 310), multiple capsules managed by the license manager 320 can be installed in the client PC 300. The invalidation information storage unit 326 stores information identifying invalidated tickets. The key storage unit 328 stores unique keys peculiar to the license manager 320. The controller 322 judges whether or not a capsule can be used and performs a process in accordance with the judgment result.

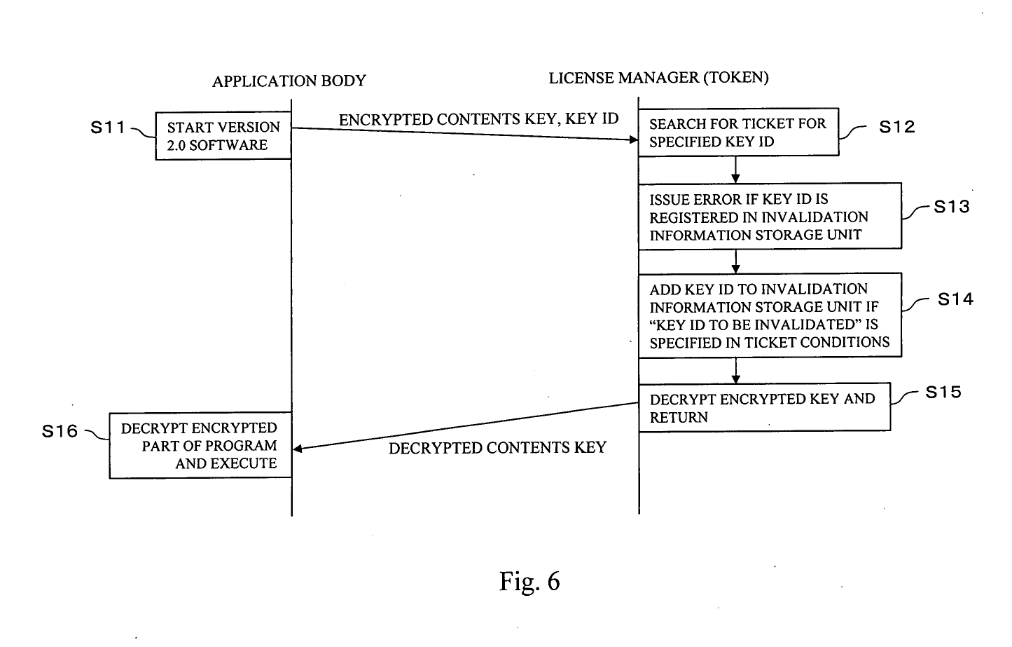

Next, a procedure executed by the client PC 300 will be described with reference to FIG. 6 when the user starts the application body 310 (capsule). In this example, the application body 310 is version 2.0 (upgrade version: key ID 1002) of the aforementioned software product A and product software A has a previous version 1.0 (key ID 1001).

First, when the upgraded version 2.0 software (application body 310) is started (S11), the control program 312 is executed. Then, the control program 312 passes the encrypted contents key 318 and the key ID 316 to the license manager 320 and requests license authentication. The controller 322 of the license manager 320, which receives this request, searches (S12) the license storage unit 324 for a ticket corresponding to the specified key ID 316. If the ticket corresponding to the key ID is not found in the license storage unit 324, the controller 322 returns an error response to the application body 310. In this case, the capsule for the application 310 cannot be decrypted and the control program 312 performs error processing and terminates. If the ticket corresponding to the key ID 316 is found, the usage conditions (such as maximum usage count and expiration date) specified on the ticket are obtained and it is checked whether the usage conditions are satisfied (S12). If the current time is past the expiration date, the usage conditions are not satisfied. Furthermore, if the usage count for the application body 310 (counted by the license manager 320 each time the application body 310 is started) exceeds the maximum usage count, the usage conditions are not satisfied. In the case where the usage conditions are not satisfied, the controller 322 also returns an error response to the application body 310 and the application body 310 performs error processing and terminates. This checking of usage conditions and the accompanying control operations are known techniques so they will not be described any further. In the depicted example, a ticket corresponding to the key ID 316 is found and the usage conditions are also satisfied.

In this case, the controller 322 further checks (S13) whether or not the key ID 316 has been registered in the invalidation information storage unit 326. If it is registered, the ticket corresponding to the key ID 316 is already invalid so that an error response is sent to the application body 310 (S13) and the application body 310 performs error processing accordingly and terminates. Either the checking operation in step S13 or the checking of the usage conditions for the ticket in step S12 may be executed first.

If the key ID 316 has not been registered in the invalidation information storage unit 326, the execution proceeds to step S14. In step S14, the usage conditions included in the ticket corresponding to the key ID 316 are checked to judge whether or not the usage conditions are satisfied. In this example, the ticket corresponding to the key ID 316 is an upgrade ticket for software product A so that the ticket is described with the usage conditions of “a ticket (key ID 1001) for previous version 1.0 exists” and “the ticket for version 1.0 is invalidated when the upgrade ticket is used”. Therefore, the controller 322 first judges whether or not the key ID (1001) ticket exists in the license storage unit 324. If the ticket does not exist, an error is returned to the application body 310. In this case, the application body 310 performs error processing and terminates. If the key ID (1001) ticket exists in the license storage unit 324, the key ID (1001) is registered into the invalidation information storage unit 326. Since a procedure has been omitted for the case where version 2.0 of the application is used two or more times, it can be judged that the usage conditions are satisfied if the key ID (1001) has already been registered in the invalidation information storage unit 326. Or a flag may be provided to indicate whether or not a usage condition process has been executed, and if the flag is on, this process may be skipped. As a result, the procedure can be performed normally when the application is used two or more times. Since the usage conditions for the version 2.0 upgrade ticket are satisfied as shown above, the controller 322 decrypts the encrypted contents key 318 and returns (S15) the decrypted contents key to the application body 310 by using information on the ticket corresponding to the key ID 316 (1002) and information on the unique key of the token itself that is stored in the key storage unit 328.

The control program 312 of the application body 310 that received the decrypted contents key decrypts the encrypted application body 314 using the contents key and executes it (S16). As a result, the user can use the application body 310.

According to this process, a ticket of a previous version is not invalidated simply by downloading the ticket for the newest version of software. Therefore, until the newest version of software is started, the ticket of the previous version can continue to be used. Then, as soon as the newest version of software is started even once, the ticket of the previous version is invalidated so that tickets of multiple versions can be prevented from existing concurrently.

Instead of performing the process of step S14 each time the application body 310 is started, a flag may be provided within the license manager 320 and mapped to the ticket of the application body 310 to indicate whether or not the application body 310 has been successfully started (or authenticated) even once, and if the flag is on (application was started), step S14 may be omitted. In this case, once the application body 310 is started, the ticket of a previous version is invalidated so that there is no problem even if step S14 is omitted.

An example of a software upgrade license was described above. As anyone skilled in the art can appreciate, the control operations can be designed so that in the case of migration licenses also, the software license for migration is not invalidated simply by installing the migration license similar to the description above but the license for migration is invalidated when the migration license is used.

An example of invalidating a related license from an upgrade license or migration license was given above. However, there are also other cases where it is convenient for a license to exert influence (or cause a side effect) on the usage conditions of another license. As a first modified example of the embodiment, a system will be described hereinafter in which a license exerts influence on the usage conditions of another license.

For example, when a license is used, a change in the usage conditions of a related license can be considered. In this case, the target license and the corresponding related license have a relationship where the usage conditions of the related license change when the target license is used. The usage conditions to be changed include the expiration date, the maximum usage count, and a usage sensitive billing rate. In this case, “the related ticket exists at the client PC” and the way the usage conditions of the related ticket are changed when the ticket is used are noted with respect to the ticket (license) to be issued.

For example, if the usage conditions for the ticket of “the ticket of key ID (1001) of the capsule of version 1.0 exists” and “the term of validity of the ticket of key ID (1001) is 7 days when the ticket of key ID (1002) is used” are set with respect to an upgrade ticket for version 2.0 (key ID 1002) software, the first time the ticket of version 2.0 on the client PC 300 is used, the term of validity of the ticket for version 1.0, which is a related license, is forcibly set from that point to 7 days. As a result, when the new version software is used, the previous version is not immediately disabled but can be disabled after the term of validity elapses.

Furthermore, if the usage conditions for the ticket of “the ticket of key ID (1001) of the capsule of version 1.0 exists” and “the maximum usage count for the ticket of the key ID (1001) is 10 when the ticket of key ID (1002) is used” are set with respect to the upgrade ticket for software version 2.0 (key ID 1002), the first time the ticket of version 2.0 on the client PC 300 is used, the maximum usage count for the ticket for version 1.0 is forcibly set to 10.

When set in this manner, the control operations can be performed so as to permit the old version of the software to be used for a while even after the use of the new version has begun.

Furthermore, when usage sensitive billing is charged, it is possible to set a preferential billing rate for other related software as soon as the new software is used. For example, if the billing rate for spreadsheet software provided by a vendor is 30 yen per day, the billing rate for the spreadsheet software is preferentially set at 20 yen per day if use of word processing software provided by the same vendor begins. In this case, the usage conditions of “the ticket of spreadsheet software (provided by the same vendor) exists” and “the billing rate for the ticket of the spreadsheet software is set to 20 yen when the ticket of the word processing software is used” are set with respect to the ticket of the word processing software.

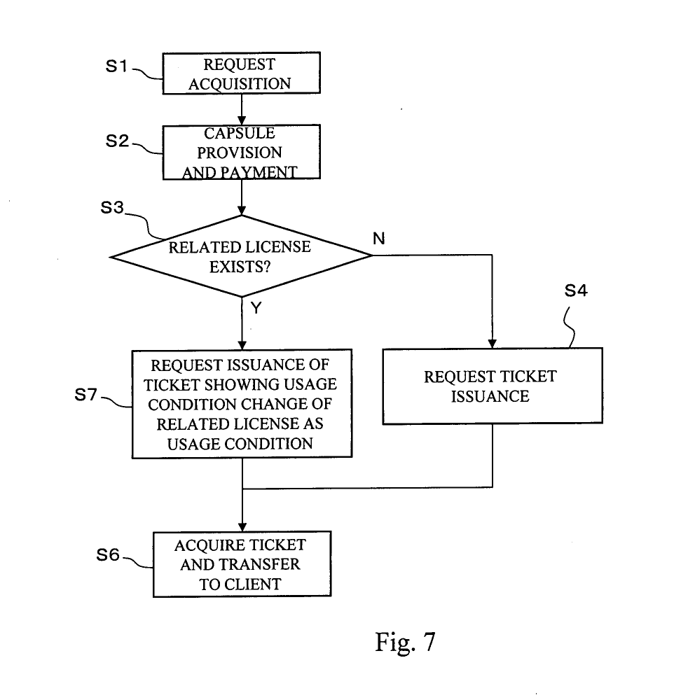

To change the usage conditions for a related license from the use of a license as described above, the contents provider server 200 performs a process as shown in FIG. 7. In FIG. 7, the steps performing identical or similar processes to those in FIG. 4 are designated like reference characters and their descriptions will be omitted.

In the procedure of FIG. 7, the contents provider server 200 issues a request (S7) to the ticket issuance server 100 for the issuance of a ticket that includes the usage condition of “when the license for the capsule is used, if a related license exists in the client PC, the value of item A in the usage conditions for the related license is set to X” (where A is the usage condition item name, such as the term of validity or expiration date, maximum usage count, billing rate, and X is the value of that item) when it is judged in step S3 that a related license to the license of the capsule provided to the client PC 300 exists. Details on the specified change in the related license may be registered into the license correlation information storage unit 230. In this case, the license key ID, the related license key ID, and details on the change in the related license are registered into the license correlation information storage unit 230 and multiple items in the usage conditions to be changed can be specified. Furthermore, if there are multiple related licenses with respect to a license, the changes in the usage conditions can be registered for each individual related license. The other processes are identical to the procedure of FIG. 4.

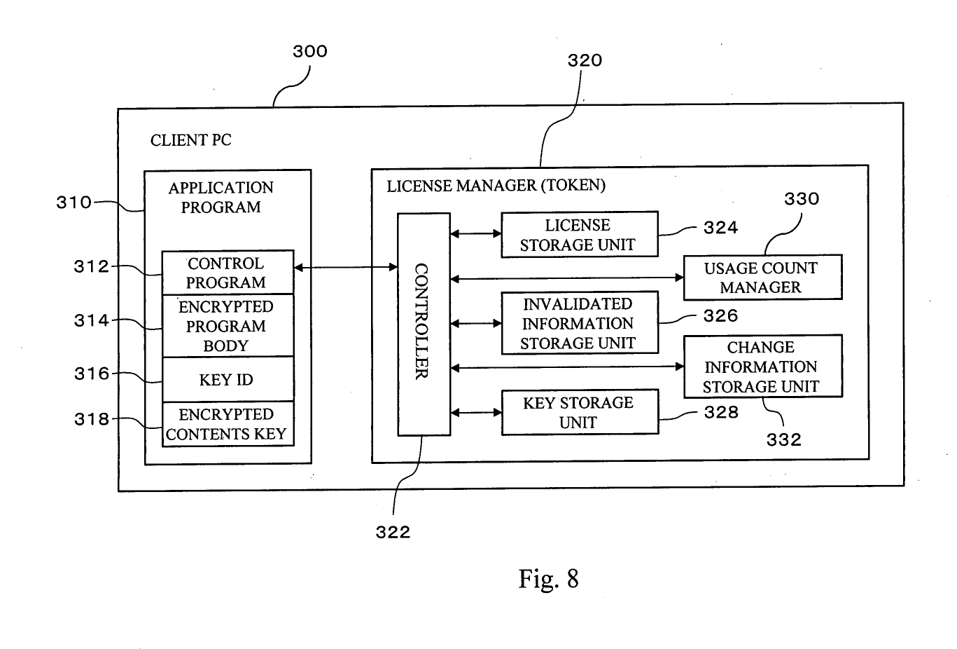

Furthermore, the corresponding client PC 300 may include the functional module shown in FIG. 8. In FIG. 8, the components identical or similar to those in FIG. 5 are designated like reference characters and their descriptions will be omitted.

In this example, the license manager 320 includes a usage count manager 330 and a change information storage unit 332. The usage count manager 320 manages the information on the usage count for each ticket stored in the license storage unit 324. Each time the use of a ticket is detected, the usage count manager 330 increments a count value of the ticket usage by 1. When a ticket is used, the details on the change in the usage conditions for the related license indicated on the ticket are registered into the change information storage unit 332. Furthermore, when a command to use a ticket is received, the controller 322 checks the change information storage unit 332 for changes in the usage conditions for the ticket, and if there is a change, the usage conditions after the change are applied with precedence.

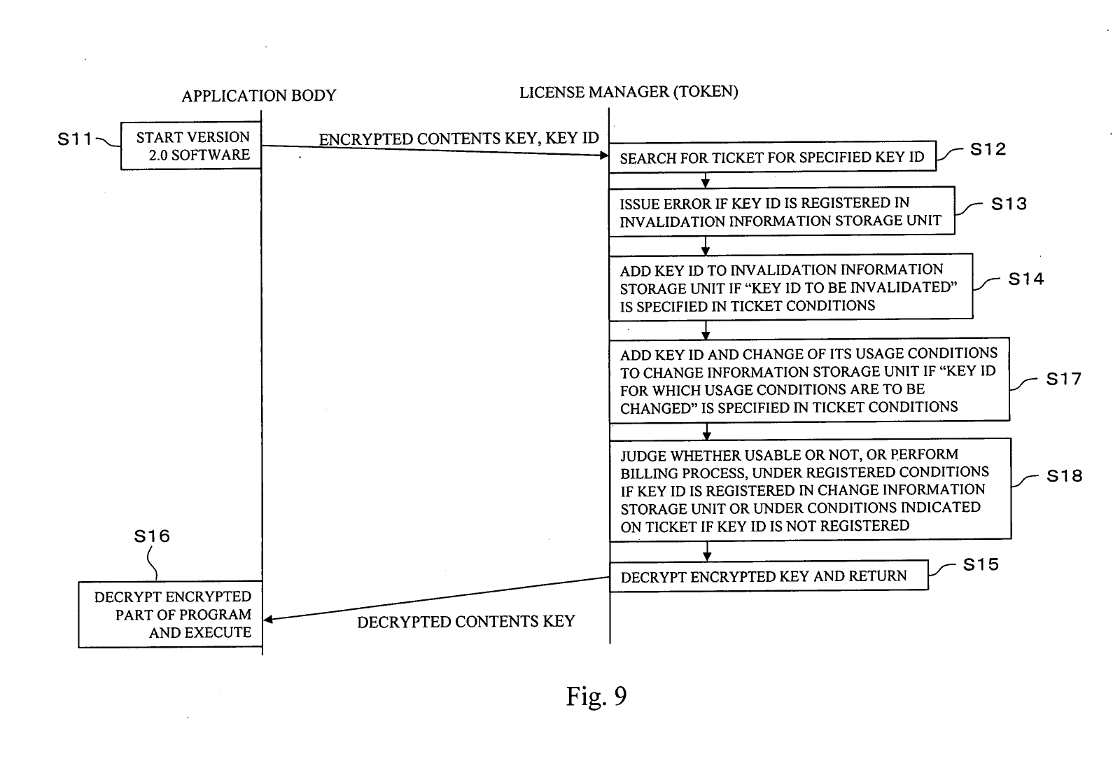

The procedure for the client PC 300 in this modified example will be described with reference to FIG. 9. In FIG. 9, the steps performing identical or similar processes to those in FIG. 6 are designated like reference characters and their descriptions will be omitted.

In this procedure, if changes in usage conditions for the related license (identified by key ID) are indicated in the usage conditions for the key ID ticket specified from the application body 310, the license manager 320 maps the changes in usage conditions for the related license with the key ID and registers them (S17) into the change information storage unit 332. Furthermore, the license manager 320 checks whether or not the key ID specified from the application body 310 has been registered in the change information storage unit 332, and if it has been registered, the changes in the usage condition items that are registered in the change information storage unit 332 are adapted (S18) instead of the usage condition items indicated on the ticket corresponding to the key ID. Namely, if a modified term of validity or expiration date has been registered in the change information storage unit 332, the license manager 320 judges whether or not the ticket is usable based on the modified term of validity or expiration date and the current time. Furthermore, if a modified maximum usage count has been registered in the change information storage unit 332, the license manager 320 judges that the ticket is unusable if the usage count for the ticket managed by the usage count manager 330 exceeds the modified maximum usage count. Moreover, if a modified usage sensitive billing rate has been registered in the change information storage unit 332, the license manager 320 calculates the billing amount for the application body 310 according to the billing rate. The billing amount obtained in this manner is, for example, recorded within the license manager 320 and transmitted by the client PC 300 either periodically or by user command to a payment server (not shown) on the network to complete payment. If payment is not made within a predetermined period or if the unpaid amount exceeds a predetermined amount recorded in the license manager 320, the license manager 320 may control the use of the application body 310 so that its use is not permitted by the user.

Even if a new value is set to a usage condition item for which a value has not been set, such as when an expiration date is provided for a ticket for which an expiration date has not been set, this is assumed to fall under the concept of a “change” in the usage condition item.

Except for the steps described above, all the other steps are identical to the procedure in FIG. 6. Furthermore, either step S14 or S17 may be executed first.

When a license was used in the aforementioned modified example, the usage conditions of the related license were changed. Conversely, when a target license is used and a related license exists in the client PC 300, the usage conditions for the target license may be changed. A second modified example for accomplishing this will be described next.

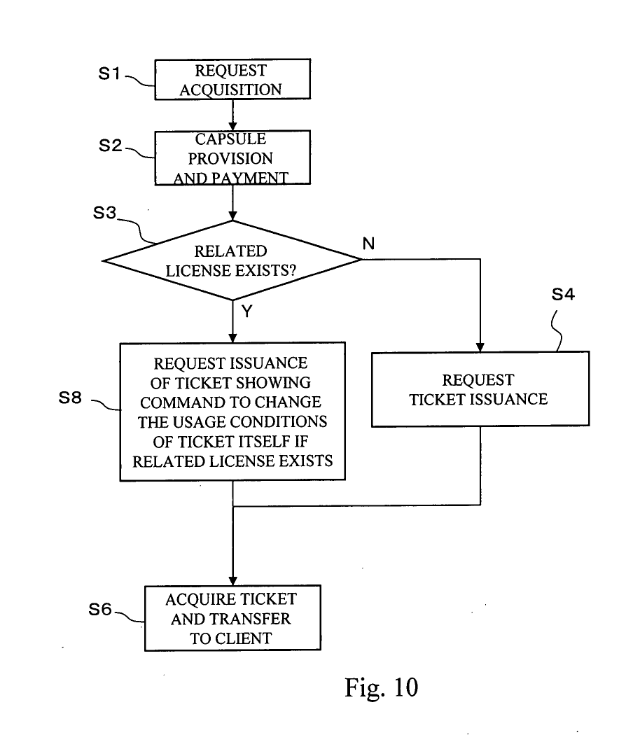

As shown in FIG. 10, if a related license to the license for the capsule that is requested from the client PC 300 exists, the contents provider server 200 in the second modified example issues a request (S8) to the ticket issuance server 100 to issue a license including a usage condition of “if a related license L2 exists in the client PC when a license L1 for the capsule is used, the value of item A in the usage conditions for the license L1 for the capsule is set to X”. The server 200 may execute the same procedure as in FIG. 4 except for step S8.

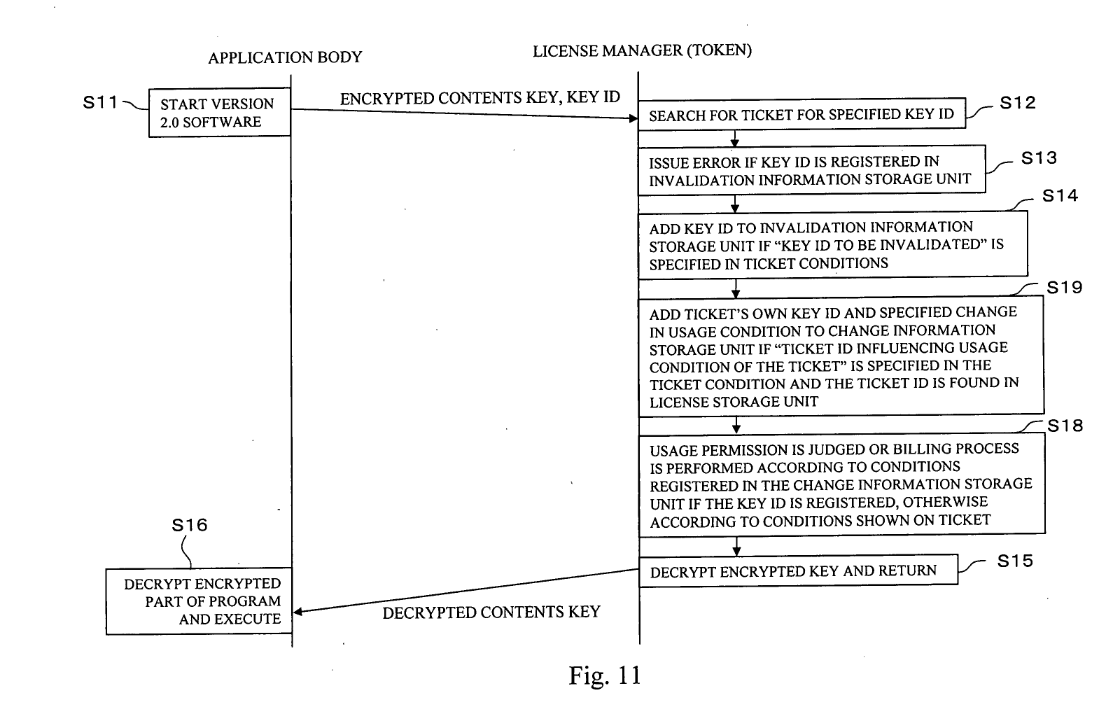

Furthermore, the procedure for the client PC 300 in the second modified example is shown in FIG. 11. In this procedure, if a usage condition of “if a related license (identified by key ID) exists in the client PC 300, the usage conditions for the license L1 for the application body 310 will be changed” is indicated for the ticket for the key ID specified from the application body 310, the license manager 320 maps the changes in the usage conditions for the license L1 to the key ID and registers (S19) them into the change information storage unit 332. The other steps may be made identical to the procedure of FIG. 9.

According to the first and second modified examples described above, using a license makes it possible to change the usage conditions of another license and provide a license migration method offering a high degree of freedom to the license user. Furthermore, providing new benefits for the license user can promote the purchase of related licenses.

In the aforementioned modified examples, tickets were invalidated and usage conditions for tickets were changed. However, a system configuration can naturally be considered in which only the latter is performed.

Although the contents provider server 200 and the ticket issuance server 100 were separate devices in the embodiment and modified examples described above, they may be packaged into one device. Furthermore, the contents provider server 200 sends a request to the ticket issuance server 100 to issue a ticket in accordance with a request from a user and the resulting issued ticket was transferred to the user. Instead, however, the ticket issuance server 100 may process a direct ticket issuance request from the user.

Furthermore, although a system and method for handling licenses for software programs were given in the examples above, it can be appreciated that a similar system and method can also be used for licenses for the use of non-program digital content, such as documents, videos, audios, and so forth.

Moreover, although an example of selling licenses for digital content was given above, license management is also applicable to fields other than sales. For example, in the field of document management, licenses describing whether or not an individual document can be used and usage conditions are issued to a user, and if the user has a document license, the document can be managed so that it can be used under the usage conditions shown for that license. In this manner, the aforementioned system and method is applicable to various fields for managing the use of digital content through a license.

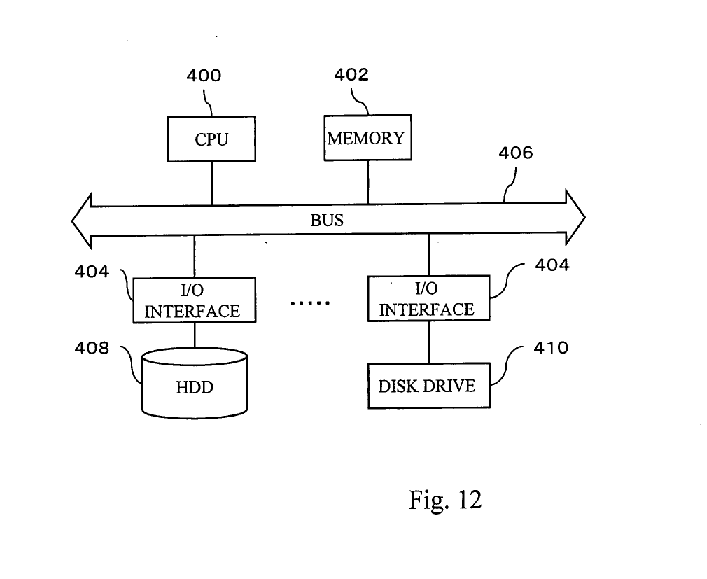

The aforementioned contents provider server 200 and the client PC 300 are each typically implemented by executing a program described with the functions and processes of each part of the aforementioned server 200 or client PC 300 on a general-purpose computer system. Regarding hardware, as shown in FIG. 12, the computer system has a circuit configuration connecting via a bus 406 a CPU (central processing unit) 400, a memory (primary storage) 402, and various I/O (input/output) interfaces 404. Furthermore, a hard disk drive 408 and a disk drive 410 for reading portable non-volatile recording media of various standards, such as CDs, DVDs, and flash memory are connected to the bus 406. The drives 408 and 410 function as external storage devices for the memory. Programs describing the processing for the aforementioned server 200 or the client PC 300 are stored in fixed storage devices, such as the hard disk drive 408, via recording media, such as CDs or DVDs, or via a network, and are installed into the computer systems. The programs stored in fixed storage devices are loaded into memory and executed by the CPU to implement the processing for the aforementioned sever 200 or the client PC 300.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A license management system comprising:
an issuance system that issues a license for digital content which includes an instruction to change a usage condition for a related license if the related license which has the usage condition to be changed exists; and
a user system that, if a license for a digital content includes an instruction to change a usage condition for a related license and the related license is stored within the user system when the use of the digital content is instructed, changes the usage condition for the related license in accordance with the instruction.

2. An issuance system for issuing a license for digital content comprising:
a judgment unit that judges whether or not there is a related license which is related to a license to be issued and includes a usage condition to be changed; and
an issuance processor that, when the judgment unit judges there is the related license, issues the license including an instruction to change the usage condition for the related license if the related license is stored within a user system.

3. The issuance system according to claim 2, wherein:
the instruction is to invalidate the related license.

4. The issuance system according to claim 2, wherein:
the instruction is to change an upper limit of usage count for the related license.

5. The issuance system according to claim 2, wherein:
the instruction is to change an expiration date for the related license.

6. The issuance system according to claim 2, wherein:
the instruction is to change a billing rate for the related license.

7. A user system for using digital content by using a license comprising:
a license storage unit that stores a first license for digital content issued from an issuance system; and
a change processor that, if a second license issued from the issuance system includes an instruction to change a usage condition for a related license and the stored first license is related to the second license when use of the digital content is instructed, changes the usage condition for the first license according to the instruction.

8. The user system according to claim 7, further comprising:
a deactivation unit that prevents the use of the digital content if the second license includes the instruction to change the usage condition for the related license and the there is not the related license stored in the license storage unit when the use of the digital content is instructed.

9. The user system according to claim 7, wherein:
the instruction is to invalidate the related license.

10. The user system according to claim 9, further comprising:
a registration unit that, if the license includes the instruction to change the usage condition for the related license and the related license is stored in the license storage unit when the use of the digital content is instructed, registers the related license into an invalidated license memory unit; and
a deactivation unit that prevents the use of digital content if there is a license for the digital content in the invalidated license memory unit when the use of the digital content is instructed.

11. The user system according to claim 9, further comprising:
a registration unit that registers the instruction for the related license into a change information manager if the license for the digital content includes the instruction to change the usage condition for the related license and the related license is stored in the license storage unit when the use of the digital content is instructed; and
a condition application unit that applies a usage condition indicated by the instruction which is registered in the change information manager to the digital content with precedence over a usage condition indicated by the license itself if there is the instruction for the license in the change information manager when the use of the digital content is instructed.

12. A computer readable medium storing a program causing a computer to execute a process for issuing a license for digital content, the process comprising:
judging whether or not a related license, which is related to a license to be issued and includes a usage condition to be changed, exists; and
if the related license is judged to exist, issuing the license which includes an instruction to change the usage condition for the related license within the user system.

13. A computer readable medium storing a program causing a computer to execute a process to use a digital content by means of a license, the process comprising:
storing a first license for digital content issued from an issuance server; and
if a second license includes an instruction to change a usage condition for a related license and the stored first license is related to the second license when use of the digital content is instructed, changing the usage condition for the first license according to the instruction.

14. A license management system comprising:
an issuance system that issues a license for digital content which includes an instruction to change a usage condition for the license if a related license influencing the usage condition for the license exists within a user system; and
an user system that, if a license for digital content includes an instruction to change a usage condition for the license and if a related license exists in the user system, when use of the digital content is instructed, changes the usage condition for the license in accordance with the instruction.

15. An issuance system for issuing licenses for digital content to a user system, the issuance system comprising:
a judgment unit that judges whether there is a related license, which is related to a license to be issued and influences a usage condition for the license, exists or not; and
an issuance processor that, when the related license is judged to exist, issues the license including an instruction to change the usage condition for the license if the related license is stored within a user system.

16. A user system for using digital content by using a license comprising:
a license storage unit that stores a first license for digital content; and
a change processor that, if the first license relates to a second license which is issued from an issuance system and if the second license includes an instruction to change a usage condition for the second license, when use of the digital content is instructed, changes the usage condition for the second license in accordance with the instruction.

17. A computer readable medium storing a program causing a computer to execute a process for issuing a license for digital content, the process comprising:
judging whether there is a related license, which is related to a license to be issued and influences a usage condition for the license, exists or not; and
when it is judged the related license exists, issuing the license which includes an instruction to change the usage condition for the license if the related license is stored within a user system.

18. A computer readable medium storing a program causing a computer to execute a process to use digital content by means of a license, the process comprising:
storing a first license for digital content; and
if the first license relates to a second license which is issued from an issuance server and if the second license includes an instruction to change a usage condition for the second license, when the use of the digital content is indicated, changing the usage condition for the second license in accordance with the instruction.
